(19) United States
(12) Patent Application Publication
(10) Pub. No.: US 2026/0145982 A1
(43) Pub. Date: May 28, 2026

(54) TWO-STAGE FORMING OF A MULTI-DIMENSIONAL GLASS-BASED ARTICLE

(71) Applicant: CORNING INCORPORATED, CORNING, NY (US)

(72) Inventors: William Jason Hill, Lindley, NY (US); Jacob Immerman, Corning, NY (US); Michael Morgan Oliver, Hammondsport, NY (US); James Prutsman, Elkland, PA (US); John Richard Ridge, Hammondsport, NY (US); John Robert Saltzer, JR., Beaver Dams, NY (US)

(21) Appl. No.: 19/395,646

(22) Filed: Nov. 20, 2025

Related U.S. Application Data
(60) Provisional application No. 63/725,807, filed on Nov. 27, 2024.

(51) Int. Cl. C03B 23/00

(52) U.S. Cl. CPC C03B 23/0013

(57) ABSTRACT

Methods for forming a multi-dimensional glass-based article includes placing a two-dimensional glass-based preform at an opening of a preform mold and heating the two-dimensional glass-based preform to a first temperature. The two-dimensional glass-based preform is introduced into a cavity of the preform mold to form a glass-based preform, and the glass-based preform is cooled to form an intermediate glass-based article. The intermediate glass-based article is placed into an intermediate mold and heated to a second temperature. The intermediate glass-based article is placed in the intermediate mold, and subsequently the intermediate glass-based article is cooled to form the multi-dimensional glass-based article.

### CROSS REFERENCE TO RELATED APPLICATION

This application claims the benefit of priority under 35 U.S.C. § 119 of U.S. Provisional Application Ser. No. 63/725,807 filed on Nov. 27, 2024, the content of which is relied upon and incorporated herein by reference in its entirety.

### BACKGROUND

Multi-dimensional glass products are becoming more prevalent today for a variety of applications in hand-held devices, laptops, the automobile industry, and VR headsets, to name a few. The designs for multi-dimensional glass-based articles are becoming deeper and more intricate. A need exists for improved methods for forming such complex, multi-dimensional glass-based articles.

### BRIEF SUMMARY

According to embodiments, a method for forming a multi-dimensional glass-based article, the method comprising: placing a two-dimensional glass-based preform at an opening of a preform mold; heating the two-dimensional glass-based preform to a first temperature; introducing the two-dimensional glass-based preform into a cavity of the preform mold to form a glass-based preform; cooling the glass-based preform to form an intermediate glass-based article; placing the intermediate glass-based article into an intermediate mold; heating the intermediate glass-based article to a second temperature; forming the intermediate glass-based article in the intermediate mold; cooling the intermediate glass-based article to form the multi-dimensional glass-based article.

According to embodiments, a method for forming a multi-dimensional glass-based article, the method comprising: placing a two-dimensional glass-based preform at an opening of a preform mold; heating the two-dimensional glass-based preform to a first temperature; sagging the two-dimensional glass-based preform into the preform mold forming a glass-based preform; cooling the glass-based preform to form an intermediate glass-based article; placing the intermediate glass-based article into an intermediate mold; holding at least a portion of a perimeter of the intermediate glass-based article to the intermediate mold; heating the intermediate glass-based article to a second temperature; forming the intermediate glass-based article in the intermediate mold; cooling the intermediate glass-based article to form the multi-dimensional glass-based article.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a schematic of a top view of a multi-dimensional glass-based article with curvature in two dimensions according to embodiments disclosed and described herein;

FIG. 1B is a schematic of a side view of a multi-dimensional glass-based article with curvature in two dimensions;

FIG. 1C is a schematic of a magnified view of the edge of a multi-dimensional glass-based article with curvature in two dimensions;

FIG. 2A is a schematic of a top view of a multi-dimensional glass-based article with curvature in three dimensions;

FIG. 2B is a schematic of a side view of a multi-dimensional glass-based article with curvature in three dimensions;

FIG. 2C is a schematic of a front view of a multi-dimensional glass-based article with curvature in three dimensions;

FIG. 3A is a schematic of a top view of a multi-dimensional glass-based article with curvature in three dimensions and a reverse curvature;

FIG. 3B is a schematic of a side view of a multi-dimensional glass-based article with curvature in three dimensions and a reverse curvature;

FIG. 3C is a schematic of a front view of a multi-dimensional glass-based article with curvature in three dimensions and a reverse curvature;

FIG. 4A is a schematic of a side view of a preform mold apparatus and two-dimensional glass-based preform comprising a press mold in a first position;

FIG. 4B is a schematic of a side view of a preform mold apparatus and two-dimensional glass-based preform comprising a second mold in a second position;

FIG. 5A is a schematic of a side view of a preform mold apparatus and a two-dimensional glass-based preform comprising a vacuum and a clamp in a first position;

FIG. 5B is a schematic of a side view of a preform mold apparatus and a two-dimensional glass-based preform comprising a vacuum and a clamp in a second position;

FIG. 6A is a schematic of a side view of an intermediate mold apparatus and an intermediate glass-based article comprising a vacuum and a clamp in a first position;

FIG. 6B is a schematic of a side view of an intermediate mold apparatus and an intermediate glass-based article comprising a vacuum and a clamp in a second position;

FIG. 7A is a schematic of a side view of an intermediate mold apparatus and an intermediate glass-based article comprising a press mold and a clamp in a first position;

FIG. 7B is a schematic of a side view of an intermediate mold apparatus and intermediate glass-based article comprising a press mold and a clamp in a second position;

FIG. 8A is a schematic of a side view of an intermediate mold apparatus and an intermediate glass-based article comprising a vacuum mold and a clamp with preferential heating; and

FIG. 8B is a schematic top view of an intermediate mold apparatus and an intermediate glass-based article with preferential heating.

### DETAILED DESCRIPTION

As mentioned above, a need exists for improved methods for forming complex, multi-dimensional glass-based articles. In particular, shapes with a global bow and tight bends around the perimeter are difficult to form in a single stage process and still maintain good alignment. With current single stage processes it is difficult to control alignment of the glass-based article to the mold. Also, single stage processes can often result in cosmetic marks on the glass associated with the glass dragging on the mold a long distance at high temperature (low viscosity). With a two stage process as disclosed and described herein, a global bow may be formed at lower temperatures (higher viscosities), which minimizes the cosmetic marks. Also, in the second stage of the two stage process, it is possible to re-align the glass-based article to the mold, which yields final glass-based articles with much better alignment to the mold.

In embodiments, a method for forming a multi-dimensional glass-based article comprises placing a two-dimensional glass-based preform at an opening of a preform mold; heating the two-dimensional glass-based preform to a first temperature; introducing the two-dimensional glass-based preform into the preform mold to form a glass-based preform; cooling the glass-based preform to form an intermediate glass-based article; placing the intermediate glass-based article into an intermediate mold; heating the intermediate glass-based article to a second temperature; forming the intermediate glass-based article into the intermediate mold; and cooling the intermediate glass-based article to form the multi-dimensional glass-based article.

In one or more embodiments, a method for forming a multi-dimensional glass-based article comprises: placing a two-dimensional glass-based preform at an opening of a preform mold; heating the two-dimensional glass-based preform to a first temperature; sagging the two-dimensional glass-based preform into the preform mold to form a glass-based preform; cooling the glass-based preform to form an intermediate glass-based article; placing the intermediate glass-based article into an intermediate mold; holding at least a portion of a perimeter of the intermediate glass-based article to the intermediate mold; heating the intermediate glass-based article to a second temperature; forming the intermediate glass-based article into the intermediate mold; cooling the intermediate glass-based article to form the multi-dimensional glass-based article.

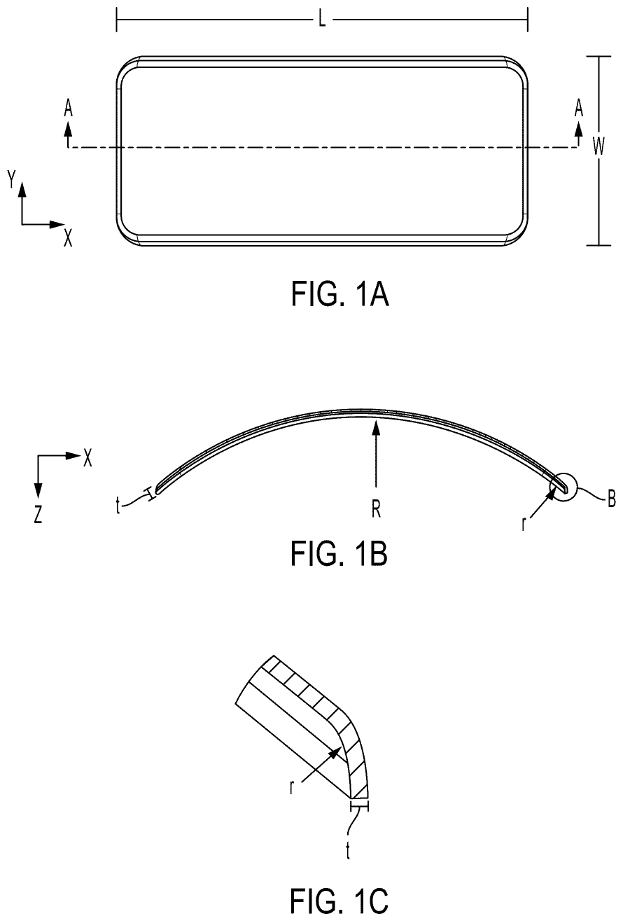

Multi-dimensional glass-based articles will now be described with reference to FIG. 1A to FIG. 1C. FIG. 1A is a top view of multi-dimensional glass-based article that has a generally rectangular shape; however, the in the embodiment depicted in FIG. 1A, the corners are rounded rather than squared. It should be understood that other shapes may be envisioned in other embodiments. As seen in FIG. 1A, the edges of the multi-dimensional glass-based article have a curvature or bezel. Although not particularly limited, in embodiments, the multi-dimensional glass-based article may have a length L that is greater than or equal to 150 mm and less than or equal to 250 mm, such as greater than or equal to 175 mm and less than or equal to 250 mm, greater than or equal to 200 mm and less than or equal to 250 mm, greater than or equal to 225 mm and less than or equal to 250 mm, greater than or equal to 150 mm and less than or equal to 225 mm, greater than or equal to 150 mm and less than or equal to 200 mm, or greater than or equal to 150 mm and less than or equal to 175 mm. In embodiments, the width W of the multi-dimensional glass-based article may be greater than or equal to 75 mm and less than or equal to 125 mm, such as greater than or equal to 100 mm and less than or equal to 125 mm, or greater than or equal to 75 mm and less than or equal to 100 mm. However, it should be understood that the length L and width W of the multi-dimensional glass-based article are not limited and can be adjusted to suit a particular end use.

In embodiments, the thickness t of the multi-dimensional glass-based article is relatively thin, such as less than or equal to 1.5 mm, less than or equal to 1.2 mm, less than or equal to 1.0 mm, less than or equal to 0.9 mm, less than or equal to 0.8 mm, less than or equal to 0.7 mm, less than or equal to 0.6 mm, or less than or equal to 0.5 mm. In one or more embodiments, the thickness t of the multi-dimensional glass-based article is greater than or equal to 0.5 mm and less than or equal to 1.5 mm, such as greater than or equal to 0.6 mm and less than or equal to 1.5 mm, greater than or equal to 0.7 mm and less than or equal to 1.5 mm, greater than or equal to 0.8 mm and less than or equal to 1.5 mm, greater than or equal to 0.9 mm and less than or equal to 1.5 mm, greater than or equal to 1.0 mm and less than or equal to 1.5 mm, greater than or equal to 1.2 mm and less than or equal to 1.5 mm, greater than or equal to 0.5 mm and less than or equal to 1.2 mm, greater than or equal to 0.6 mm and less than or equal to 1.2 mm, greater than or equal to 0.7 mm and less than or equal to 1.2 mm, greater than or equal to 0.8 mm and less than or equal to 1.2 mm, greater than or equal to 0.9 mm and less than or equal to 1.2 mm, greater than or equal to 1.0 mm and less than or equal to 1.2 mm, greater than or equal to 0.5 mm and less than or equal to 1.0 mm, greater than or equal to 0.6 mm and less than or equal to 1.0 mm, greater than or equal to 0.7 mm and less than or equal to 1.0 mm, greater than or equal to 0.8 mm and less than or equal to 1.0 mm, greater than or equal to 0.9 mm and less than or equal to 1.0 mm, greater than or equal to 0.5 mm and less than or equal to 0.9 mm, greater than or equal to 0.6 mm and less than or equal to 0.9 mm, greater than or equal to 0.7 mm and less than or equal to 0.9 mm, greater than or equal to 0.8 mm and less than or equal to 0.9 mm, greater than or equal to 0.5 mm and less than or equal to 0.8 mm, greater than or equal to 0.6 mm and less than or equal to 0.8 mm, greater than or equal to 0.7 mm and less than or equal to 0.8 mm, greater than or equal to 0.5 mm and less than or equal to 0.7 mm, greater than or equal to 0.6 mm and less than or equal to 0.7 mm, or greater than or equal to 0.5 mm and less than or equal to 0.6 mm.

FIG. 1B is a side view of a multi-dimensional glass-based article that shows the curvature of the multi-dimensional glass-based article. The multi-dimensional glass-based article has global bow defined by a central radius R of curvature, and a bend radius r at the perimeter of the multi-dimensional glass-based article. The central radius R of curvature is, in embodiments, greater than or equal to 75 mm and less than or equal to 200 mm, such as greater than or equal to 100 mm and less than or equal to 200 mm, greater than or equal to 125 mm and less than or equal to 200 mm, greater than or equal to 150 mm and less than or equal to 200 mm, greater than or equal to 175 mm and less than or equal to 200 mm, greater than or equal to 75 mm and less than or equal to 175 mm, greater than or equal to 100 mm and less than or equal to 175 mm, greater than or equal to 125 mm and less than or equal to 175 mm, greater than or equal to 150 mm and less than or equal to 175 mm, greater than or equal to 75 mm and less than or equal to 150 mm, greater than or equal to 100 mm and less than or equal to 150 mm, greater than or equal to 125 mm and less than or equal to 150 mm, greater than or equal to 75 mm and less than or equal to 125 mm, greater than or equal to 100 mm and less than or equal to 125 mm, or greater than or equal to 75 mm and less than or equal to 100 mm.

FIG. 1C is a detailed view of the bend radius r at the perimeter of the multi-dimensional glass-based article according to embodiments. As shown in FIG. 1C, the bend radius r defines a tight curve at the perimeter of the multi-dimensional glass-based article that is different from the bow of the multi-dimensional glass-based article defined by the central radius R of curvature. In embodiments, the bend radius r is greater than or equal to 1 mm and less than or equal to 15 mm, such as greater than or equal to 2 mm and less than or equal to 15 mm, greater than or equal to 5 mm and less than or equal to 15 mm, greater than or equal to 8 mm and less than or equal to 15 mm, greater than or equal to 10 mm and less than or equal to 15 mm, greater than or equal to 12 mm and less than or equal to 15 mm, greater than or equal to 1 mm and less than or equal to 12 mm, greater than or equal to 2 mm and less than or equal to 12 mm, greater than or equal to 5 mm and less than or equal to 12 mm, greater than or equal to 8 mm and less than or equal to 12 mm, greater than or equal to 10 mm and less than or equal to 12 mm, greater than or equal to 1 mm and less than or equal to 10 mm, greater than or equal to 2 mm and less than or equal to 10 mm, greater than or equal to 5 mm and less than or equal to 10 mm, greater than or equal to 8 mm and less than or equal to 10 mm, greater than or equal to 1 mm and less than or equal to 8 mm, greater than or equal to 2 mm and less than or equal to 8 mm, greater than or equal to 5 mm and less than or equal to 8 mm, greater than or equal to 1 mm and less than or equal to 5 mm, greater than or equal to 2 mm and less than or equal to 5 mm, or greater than or equal to 1 mm and less than or equal to 2 mm.

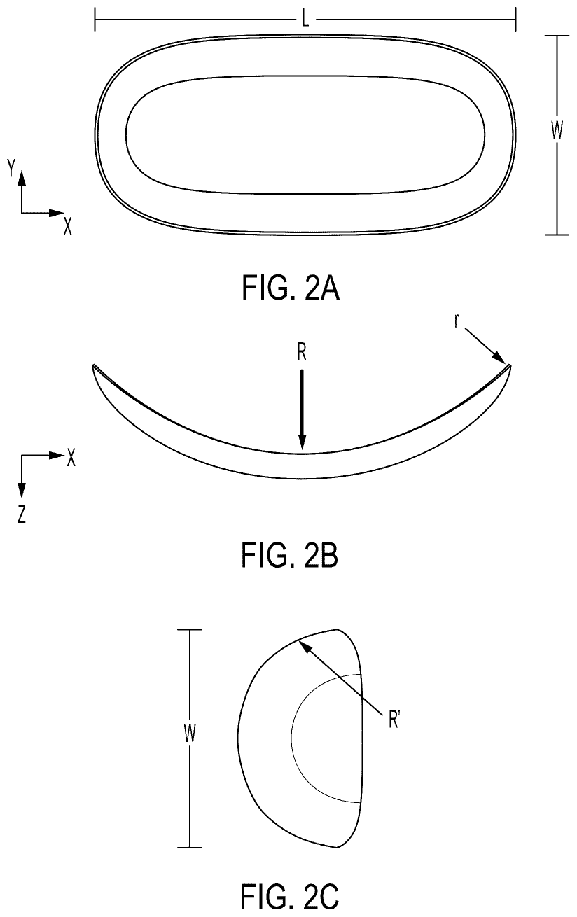

Another multi-dimensional glass-based article according to embodiments will be described with reference to FIG. 2A to FIG. 2C. The multi-dimensional glass-based article has a global bow in two dimensions and a bend radius r at the perimeter of the multi-dimensional glass-based article. Although not particularly limited, in embodiments, the multi-dimensional glass-based article shown in FIG. 2A may have a length L that is greater than or equal to 150 mm and less than or equal to 250 mm, such as greater than or equal to 175 mm and less than or equal to 250 mm, greater than or equal to 200 mm and less than or equal to 250 mm, greater than or equal to 225 mm and less than or equal to 250 mm, greater than or equal to 150 mm and less than or equal to 225 mm, greater than or equal to 150 mm and less than or equal to 200 mm, or greater than or equal to 150 mm and less than or equal to 175 mm. In embodiments, the width W of the multi-dimensional glass-based article may be greater than or equal to 75 mm and less than or equal to 125 mm, such as greater than or equal to 100 mm and less than or equal to 125 mm, or greater than or equal to 75 mm and less than or equal to 100 mm. However, it should be understood that the length L and width W of the multi-dimensional glass-based article are not limited and can be adjusted to suit a particular end use.

FIG. 2B shows a global bow in both the x-dimension and the z-dimension of the multi-dimensional glass-based article where the central radius R of curvature defines the global bow in the x-dimension. In embodiments, the central radius R of curvature is greater than or equal to 75 mm and less than or equal to 200 mm, such as greater than or equal to 100 mm and less than or equal to 200 mm, greater than or equal to 125 mm and less than or equal to 200 mm, greater than or equal to 150 mm and less than or equal to 200 mm, greater than or equal to 175 mm and less than or equal to 200 mm, greater than or equal to 75 mm and less than or equal to 175 mm, greater than or equal to 100 mm and less than or equal to 175 mm, greater than or equal to 125 mm and less than or equal to 175 mm, greater than or equal to 150 mm and less than or equal to 175 mm, greater than or equal to 75 mm and less than or equal to 150 mm, greater than or equal to 100 mm and less than or equal to 150 mm, greater than or equal to 125 mm and less than or equal to 150 mm, greater than or equal to 75 mm and less than or equal to 125 mm, greater than or equal to 100 mm and less than or equal to 125 mm, or greater than or equal to 75 mm and less than or equal to 100 mm. The multi-dimensional glass-based article has a secondary radius R′ of curvature that defines the global bow in the z-dimension.

FIG. 2B and FIG. 2C show the secondary radius R′ of curvature of the multi-dimensional glass-based article and, in embodiments, the secondary radius R′ of curvature is greater than or equal to 5 mm and less than or equal to 50 mm, such as greater than or equal to 10 mm and less than or equal to 50 mm, greater than or equal to 15 mm and less than or equal to 50 mm, greater than or equal to 20 mm and less than or equal to 50 mm, greater than or equal to 25 mm and less than or equal to 50 mm, greater than or equal to 30 mm and less than or equal to 50 mm, greater than or equal to 35 mm and less than or equal to 50 mm, greater than or equal to 40 mm and less than or equal to 50 mm, greater than or equal to 45 mm and less than or equal to 50 mm, greater than or equal to 5 mm and less than or equal to 45 mm, greater than or equal to 10 mm and less than or equal to 45 mm, greater than or equal to 15 mm and less than or equal to 45 mm, greater than or equal to 20 mm and less than or equal to 45 mm, greater than or equal to 25 mm and less than or equal to 45 mm, greater than or equal to 30 mm and less than or equal to 45 mm, greater than or equal to 35 mm and less than or equal to 45 mm, greater than or equal to 40 mm and less than or equal to 45 mm, greater than or equal to 5 mm and less than or equal to 40 mm, greater than or equal to 10 mm and less than or equal to 40 mm, greater than or equal to 15 mm and less than or equal to 40 mm, greater than or equal to 20 mm and less than or equal to 40 mm, greater than or equal to 25 mm and less than or equal to 40 mm, greater than or equal to 30 mm and less than or equal to 40 mm, greater than or equal to 35 mm and less than or equal to 40 mm, greater than or equal to 5 mm and less than or equal to 35 mm, greater than or equal to 10 mm and less than or equal to 35 mm, greater than or equal to 15 mm and less than or equal to 35 mm, greater than or equal to 20 mm and less than or equal to 35 mm, greater than or equal to 25 mm and less than or equal to 35 mm, greater than or equal to 30 mm and less than or equal to 35 mm, greater than or equal to 5 mm and less than or equal to 30 mm, greater than or equal to 10 mm and less than or equal to 30 mm, greater than or equal to 15 mm and less than or equal to 30 mm, greater than or equal to 20 mm and less than or equal to 30 mm, greater than or equal to 25 mm and less than or equal to 30 mm, greater than or equal to 5 mm and less than or equal to 25 mm, greater than or equal to 10 mm and less than or equal to 25 mm, greater than or equal to 15 mm and less than or equal to 25 mm, greater than or equal to 20 mm and less than or equal to 25 mm, greater than or equal to 5 mm and less than or equal to 20 mm, greater than or equal to 10 mm and less than or equal to 20 mm, greater than or equal to 15 mm and less than or equal to 20 mm, greater than or equal to 5 mm and less than or equal to 15 mm, greater than or equal to 10 mm and less than or equal to 15 mm, or greater than or equal to 5 mm and less than or equal to 10 mm.

As shown in FIG. 2B and FIG. 2C, the bend radius r is, according to embodiments, is greater than or equal to 1 mm and less than or equal to 15 mm, such as greater than or equal to 2 mm and less than or equal to 15 mm, greater than or equal to 5 mm and less than or equal to 15 mm, greater than or equal to 8 mm and less than or equal to 15 mm, greater than or equal to 10 mm and less than or equal to 15 mm, greater than or equal to 12 mm and less than or equal to 15 mm, greater than or equal to 1 mm and less than or equal to 12 mm, greater than or equal to 2 mm and less than or equal to 12 mm, greater than or equal to 5 mm and less than or equal to 12 mm, greater than or equal to 8 mm and less than or equal to 12 mm, greater than or equal to 10 mm and less than or equal to 12 mm, greater than or equal to 1 mm and less than or equal to 10 mm, greater than or equal to 2 mm and less than or equal to 10 mm, greater than or equal to 5 mm and less than or equal to 10 mm, greater than or equal to 8 mm and less than or equal to 10 mm, greater than or equal to 1 mm and less than or equal to 8 mm, greater than or equal to 2 mm and less than or equal to 8 mm, greater than or equal to 5 mm and less than or equal to 8 mm, greater than or equal to 1 mm and less than or equal to 5 mm, greater than or equal to 2 mm and less than or equal to 5 mm, or greater than or equal to 1 mm and less than or equal to 2 mm.

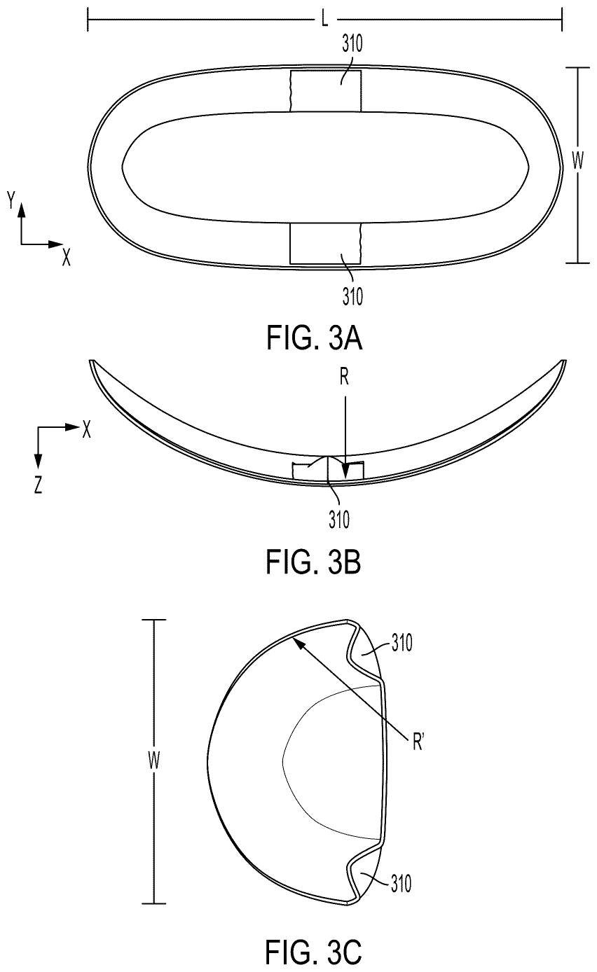

Another multi-dimensional glass-based article according to embodiments will be described with reference to FIG. 3A to FIG. 3C. The multi-dimensional glass-based article has a global bow in two dimensions and a bend radius r at the perimeter of the multi-dimensional glass-based article. Although not particularly limited, in embodiments, the multi-dimensional glass-based article shown in FIG. 3A may have a length L that is greater than or equal to 150 mm and less than or equal to 250 mm, such as greater than or equal to 175 mm and less than or equal to 250 mm, greater than or equal to 200 mm and less than or equal to 250 mm, greater than or equal to 225 mm and less than or equal to 250 mm, greater than or equal to 150 mm and less than or equal to 225 mm, greater than or equal to 150 mm and less than or equal to 200 mm, or greater than or equal to 150 mm and less than or equal to 175 mm. In embodiments, the width W of the multi-dimensional glass-based article may be greater than or equal to 75 mm and less than or equal to 125 mm, such as greater than or equal to 100 mm and less than or equal to 125 mm, or greater than or equal to 75 mm and less than or equal to 100 mm. However, it should be understood that the length L and width W of the multi-dimensional glass-based article are not limited and can be adjusted to suit a particular end use.

FIG. 3B shows a global bow in both the x-dimension and the z-dimension of the multi-dimensional glass-based article where the central radius R of curvature defines the global bow in the x-dimension. In embodiments, the central radius R of curvature is greater than or equal to 75 mm and less than or equal to 200 mm, such as greater than or equal to 100 mm and less than or equal to 200 mm, greater than or equal to 125 mm and less than or equal to 200 mm, greater than or equal to 150 mm and less than or equal to 200 mm, greater than or equal to 175 mm and less than or equal to 200 mm, greater than or equal to 75 mm and less than or equal to 175 mm, greater than or equal to 100 mm and less than or equal to 175 mm, greater than or equal to 125 mm and less than or equal to 175 mm, greater than or equal to 150 mm and less than or equal to 175 mm, greater than or equal to 75 mm and less than or equal to 150 mm, greater than or equal to 100 mm and less than or equal to 150 mm, greater than or equal to 125 mm and less than or equal to 150 mm, greater than or equal to 75 mm and less than or equal to 125 mm, greater than or equal to 100 mm and less than or equal to 125 mm, or greater than or equal to 75 mm and less than or equal to 100 mm. The multi-dimensional glass-based article has a secondary radius R′ of curvature that defines the global bow in the z-dimension.

FIG. 3B and FIG. 3C show the secondary radius R′ of curvature of the multi-dimensional glass-based article and, in embodiments, the secondary radius R′ of curvature is greater than or equal to 5 mm and less than or equal to 50 mm, such as greater than or equal to 10 mm and less than or equal to 50 mm, greater than or equal to 15 mm and less than or equal to 50 mm, greater than or equal to 20 mm and less than or equal to 50 mm, greater than or equal to 25 mm and less than or equal to 50 mm, greater than or equal to 30 mm and less than or equal to 50 mm, greater than or equal to 35 mm and less than or equal to 50 mm, greater than or equal to 40 mm and less than or equal to 50 mm, greater than or equal to 45 mm and less than or equal to 50 mm, greater than or equal to 5 mm and less than or equal to 45 mm, greater than or equal to 10 mm and less than or equal to 45 mm, greater than or equal to 15 mm and less than or equal to 45 mm, greater than or equal to 20 mm and less than or equal to 45 mm, greater than or equal to 25 mm and less than or equal to 45 mm, greater than or equal to 30 mm and less than or equal to 45 mm, greater than or equal to 35 mm and less than or equal to 45 mm, greater than or equal to 40 mm and less than or equal to 45 mm, greater than or equal to 5 mm and less than or equal to 40 mm, greater than or equal to 10 mm and less than or equal to 40 mm, greater than or equal to 15 mm and less than or equal to 40 mm, greater than or equal to 20 mm and less than or equal to 40 mm, greater than or equal to 25 mm and less than or equal to 40 mm, greater than or equal to 30 mm and less than or equal to 40 mm, greater than or equal to 35 mm and less than or equal to 40 mm, greater than or equal to 5 mm and less than or equal to 35 mm, greater than or equal to 10 mm and less than or equal to 35 mm, greater than or equal to 15 mm and less than or equal to 35 mm, greater than or equal to 20 mm and less than or equal to 35 mm, greater than or equal to 25 mm and less than or equal to 35 mm, greater than or equal to 30 mm and less than or equal to 35 mm, greater than or equal to 5 mm and less than or equal to 30 mm, greater than or equal to 10 mm and less than or equal to 30 mm, greater than or equal to 15 mm and less than or equal to 30 mm, greater than or equal to 20 mm and less than or equal to 30 mm, greater than or equal to 25 mm and less than or equal to 30 mm, greater than or equal to 5 mm and less than or equal to 25 mm, greater than or equal to 10 mm and less than or equal to 25 mm, greater than or equal to 15 mm and less than or equal to 25 mm, greater than or equal to 20 mm and less than or equal to 25 mm, greater than or equal to 5 mm and less than or equal to 20 mm, greater than or equal to 10 mm and less than or equal to 20 mm, greater than or equal to 15 mm and less than or equal to 20 mm, greater than or equal to 5 mm and less than or equal to 15 mm, greater than or equal to 10 mm and less than or equal to 15 mm, or greater than or equal to 5 mm and less than or equal to 10 mm.

As shown in FIG. 3B and FIG. 3C, the bend radius r is, according to embodiments, is greater than or equal to 1 mm and less than or equal to 15 mm, such as greater than or equal to 2 mm and less than or equal to 15 mm, greater than or equal to 5 mm and less than or equal to 15 mm, greater than or equal to 8 mm and less than or equal to 15 mm, greater than or equal to 10 mm and less than or equal to 15 mm, greater than or equal to 12 mm and less than or equal to 15 mm, greater than or equal to 1 mm and less than or equal to 12 mm, greater than or equal to 2 mm and less than or equal to 12 mm, greater than or equal to 5 mm and less than or equal to 12 mm, greater than or equal to 8 mm and less than or equal to 12 mm, greater than or equal to 10 mm and less than or equal to 12 mm, greater than or equal to 1 mm and less than or equal to 10 mm, greater than or equal to 2 mm and less than or equal to 10 mm, greater than or equal to 5 mm and less than or equal to 10 mm, greater than or equal to 8 mm and less than or equal to 10 mm, greater than or equal to 1 mm and less than or equal to 8 mm, greater than or equal to 2 mm and less than or equal to 8 mm, greater than or equal to 5 mm and less than or equal to 8 mm, greater than or equal to 1 mm and less than or equal to 5 mm, greater than or equal to 2 mm and less than or equal to 5 mm, or greater than or equal to 1 mm and less than or equal to 2 mm.

The multi-dimensional glass-based article depicted in FIG. 3A to FIG. 3C also has a pair of reverse curvature portions 310 that present themselves as indentations in the multi-dimensional glass-based article. These reverse curvature portions 310 are not particularly limited in size or shape, but show the complex geometries that may be formed by embodiments disclosed and described herein.

Methods for forming multi-dimensional glass-based articles as disclosed hereinabove, as well as other multi-dimensional glass-based articles, will now be described. In one or more embodiments, a method for forming a multi-dimensional glass-based article comprises: placing a two-dimensional glass-based preform at an opening of a preform mold; heating the two-dimensional glass-based preform to a first temperature; introducing the two-dimensional glass-based preform into the preform mold to form a glass-based preform; cooling the glass-based preform to form an intermediate glass-based article; placing the intermediate glass-based article into an intermediate mold; heating the intermediate glass-based article to a second temperature; forming the intermediate glass-based article into the intermediate mold; and cooling the intermediate glass-based article to form the multi-dimensional glass-based article.

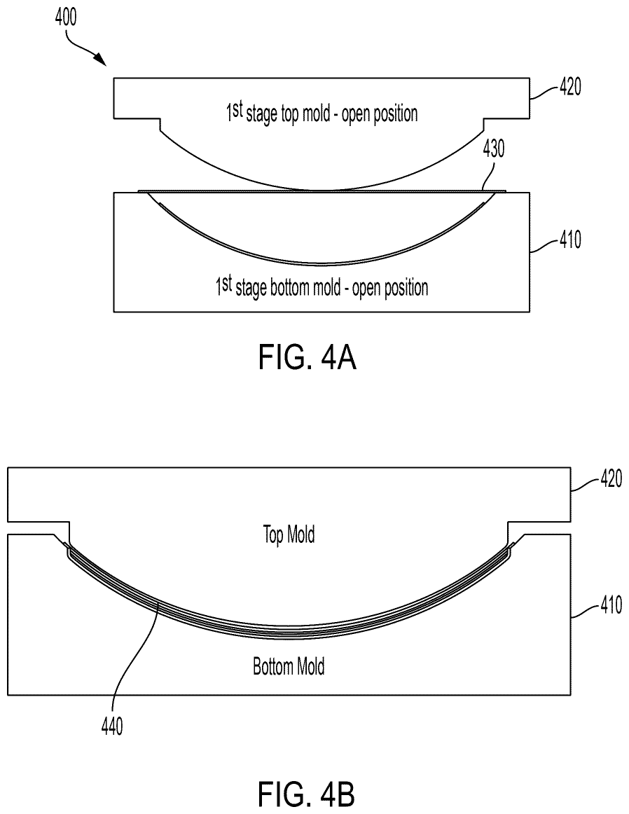

Accordingly, embodiments disclosed and described herein are directed to a two-stage molding process. The two-stage molding processes disclosed and described herein address various issues that are present in single-stage molding processes. For instance, in single-stage molding processes, the two-dimensional glass-based preform 430 has a far distance to fall into the mold and it is difficult for the preform to stay aligned in a bottom mold when it is pressed by a top mold. In addition, in single-stage molding processes, the two-dimensional glass-based preform drags on the edges of the bottom mold during forming, which can cause a myriad of defects. In addition, generally a single-stage molding process that uses a two-part mold will require a larger overall mold stack height and a larger stroke is needed to form the final glass-based article than with a two-stage molding process. This larger overall mold stack and larger stroke can lead to additional defects in the final glass-based article. Embodiments of methods for forming glass-based articles that address these, and other, issues of single-stage molding processes will now be described with reference to FIG. 4.

The composition of the two-dimensional glass-based preform 430 is not particularly limited and, in embodiments, the two-dimensional glass-based preform 430 may be an amorphous glass preform, a ceramic preform, or a glass-ceramic preform. The glass-ceramic preform comprises amorphous glass phases and ceramic phases in the preform. According to embodiments, the glass-ceramic preform may comprise greater than or equal to 20 vol. % and less than or equal to 60 vol. % ceramic phase, such as greater than or equal to 20 vol. % and less than or equal to 40 vol. % ceramic phase, or greater than or equal to 40 vol. % and less than or equal to 60 vol. % ceramic phase. It should be understood that in each of the above embodiments of glass-ceramic preforms, the remaining volume (i.e., the volume that is not ceramic phase) is an amorphous glass phase.

FIG. 4 depicts a mold apparatus 400 for forming a multi-dimensional glass-based article. The mold apparatus 400 includes a preform mold 410 and a mold press 420. In embodiments, the preform mold 410 and the mold press 420 are separate devices. In other embodiments, the preform mold 410 and the mold press 420 are integrated pieces of the same device. A two-dimensional glass-based preform 430 is placed at an opening of the preform mold 410. The two-dimensional glass-based preform 430 has a length L, a width W, and a thickness t, but does not have a global curvature or curvature at the perimeter of the two-dimensional glass-based preform 430. It should be understood that the manner by which the two-dimensional glass-based preform 430 is placed at the opening of the preform mold 410 is not limited and any suitable manner may be used.

Once the two-dimensional glass-based preform is placed at the opening of the preform mold 410, the two-dimensional glass-based preform 430 is heated to a first temperature. The first temperature is such that the viscosity of the two-dimensional glass-based preform decreases and allows the two-dimensional glass-based preform to be molded. In embodiments, the first temperature at which the two-dimensional glass-based preform is heated is such that the two-dimensional glass-based preform has a viscosity that is greater than or equal to 10⁹ poise and less than or equal to 10¹¹ poise, such as greater than or equal to 10¹⁰ poise and less than or equal to 10¹¹ poise, greater than or equal to 10⁹ poise and less than or equal to 10¹⁰ poise, or about 10¹⁰ poise. It should be understood that the two-dimensional glass-based preform 430 can be heated by any suitable method.

After the two-dimensional glass-based preform 430 is heated to the first temperature, it is introduced into the preform mold 410. In embodiments, the two-dimensional glass-based preform 430 is introduced into the preform mold 410 by gravity sagging. In such embodiments, the two-dimensional glass-based preform 430 is heated to temperature such that the viscosity of the two-dimensional glass-based preform 430 is low enough that it sags into the preform mold 410 under the force of gravity without introducing a vacuum or any physical manipulation to force the two-dimensional glass-based preform 430 to be introduced into the preform mold 410.

In one or more embodiments, the two-dimensional glass-based preform 430 is introduced into the preform mold 410 by pressing, vacuum sagging, or differential pressure sagging. Where the two-dimensional glass-based preform 430 is introduced into the preform mold 410 by pressing, the mold press 420 may be used to physically introduce the two-dimensional glass-based preform into the preform mold 410 by moving the mold press 420 toward the two-dimensional glass-based preform 430 until the mold press 420 contacts the two-dimensional glass-based preform 430 and physically pushes the two-dimensional glass-based preform 430 into the preform mold 410. In embodiments, the mold press 420 is moved slowly toward the two-dimensional glass-based preform 430 and only a small amount of pressure is placed on the two-dimensional glass-based preform 430 to introduce the two-dimensional glass-based preform 430 into the preform mold 410. By not placing too much pressure on the two-dimensional glass-based preform 430 to introduce the two-dimensional glass-based preform 430 into the preform mold 410 wrinkling, warping, and other damage may be mitigated or prevented during the introduction of the two-dimensional glass-based preform 430 into the preform mold 410.

In embodiments where the two-dimensional glass-based preform 430 is introduced into the preform mold 410 by vacuum sagging, a vacuum is formed between the two-dimensional glass-based preform 430 and the preform mold 410, such as by securing or sealing the two-dimensional glass-based preform 430 to the preform mold 410 and removing the gas between the two-dimensional glass-based preform 430 and the preform mold 410 by any suitable vacuum apparatus. In embodiments, the vacuum formed between the two-dimensional glass-based preform 430 and the preform mold 410 is not a strong vacuum. By using a weak vacuum, wrinkling, warping, and other damage may be mitigated or prevented during the introduction of the two-dimensional glass-based preform 430 into the preform mold 410.

In embodiments where the two-dimensional glass-based preform 430 is introduced into the preform mold 410 by differential pressure sagging, a pressure differential is formed between the two-dimensional glass-based preform 430 and the preform mold 410, such that a pressure in a region between the two-dimensional glass-based preform 430 and the preform mold 410 is lower than a pressure outside on the opposing side of the two-dimensional glass-based preform 430. This may, in embodiments, be achieved by securing or sealing the two-dimensional glass-based preform 430 to the preform mold 410 and increasing the pressure outside of the region formed between the two-dimensional glass-based preform 430 and the preform mold 410 by any suitable pumping mechanism. In embodiments, the pressure differential in a region between the two-dimensional glass-based preform 430 and the preform mold 410 and a region on the opposite side of the two-dimensional glass-based preform 430 is not a large pressure differential. By using a small pressure differential, wrinkling, warping, and other damage may be mitigated or prevented during the introduction of the two-dimensional glass-based preform 430 into the preform mold 410.

Once the two-dimensional glass-based preform 430 is introduced into the preform mold 410 it takes on a general bow as discussed hereinabove that coincides with the shape of the preform mold 410. Accordingly, after being introduced into the preform mold 410, the two-dimensional glass-based preform 430 no longer has a two-dimensional shape and is referred to herein as a glass-based preform 440. Once the glass-based preform 440 matches the shape of the preform mold 410, the glass-based preform 440 is cooled to form an intermediate glass-based article. The cooling of the glass-based preform 440 may be to ambient temperature or may be above ambient temperature. However, according to one or more embodiments, the glass-based preform 440 is cooled to a temperature such that the viscosity of the glass-based preform 440 rises and the glass-based preform 440 is no longer easily formable. In embodiments, the glass-based preform 440 is cooled by active cooling, such as by flowing cold gas over the glass-based preform 440 or introducing a cool liquid to the glass-based preform 440. The flowing of cold gas or quenching with a cool liquid may continue until the glass-based preform 440 reaches the desired temperature. In one or more embodiments the glass-based preform 440 is cooled by passive cooling where the glass-based preform 440 is allowed to cool by exposing the glass-based preform 440 to ambient temperatures.

The intermediate glass-based article, which has been cooled from the first temperature, is then placed into an intermediate mold. In embodiments, the intermediate mold and the preform mold 410 are different molds and placing the intermediate glass-based article into the intermediate mold comprises removing the intermediate glass-based article from the preform mold 410 and placing it in a different intermediate mold. The different intermediate mold may have the same or different geometry from the preform mold 410. In one or more embodiments, the preform mold 410 and the intermediate mold are the same mold. In such embodiments, the intermediate glass-based article is placed into the intermediate mold by keeping the intermediate glass-based article in the preform mold 410 after the intermediate glass-based article has been cooled from the first temperature.

Once the intermediate glass-based article is placed in the intermediate mold—whether the intermediate mold is a different mold than the preform mold or the intermediate mold is the same mold as the preform mold—the intermediate glass-based article is heated to a second temperature. The second temperature is such that the viscosity of the intermediate glass-based article decreases and allows the intermediate glass-based article to be further molded. In embodiments, the second temperature at which the intermediate glass-based article is heated is such that the intermediate glass-based article has a viscosity that is greater than or equal to 10⁹ poise and less than or equal to 10¹¹ poise, such as greater than or equal to 10¹⁰ poise and less than or equal to 10¹¹ poise, greater than or equal to 10⁹ poise and less than or equal to 10¹⁰ poise, or about 10¹⁰ poise. In embodiments, the first temperature is less than the second temperature. In other embodiments, the first temperature is greater than the second temperature. By heating the intermediate glass-based article to lower temperatures, thereby allowing the intermediate glass-based article to have a higher viscosity, cosmetic defects in the glass-based article can be mitigated or prevented. It should be understood that the intermediate glass-based article can be heated by any suitable method.

Once the intermediate glass-based article is heated to the second temperature, the intermediate glass-based article is formed into the intermediate mold. This forming may provide further definition of the general bow of the intermediate glass-based article, or this forming may form the bend radius r at the perimeter of the intermediate glass-based article, or this forming may provide further definition of the general bow of the intermediate glass-based article and form the bend radius r at the perimeter of the intermediate glass-based article. In one or more embodiments, the intermediate glass-based article is formed in the intermediate mold by pressing, vacuum forming, or differential pressure forming. Where the intermediate glass-based article is formed in the intermediate mold by pressing, a mold press 420, which may be the same or different mold press 420 that was used to introduce the two-dimensional glass-based preform into the preform mold, may be used to physically form the intermediate glass-based article in the intermediate mold by moving the mold press 420 toward the intermediate glass-based article until the mold press 420 contacts the intermediate glass-based article and physically pushes against the intermediate glass-based article to hold the intermediate glass-based article in the intermediate mold, as depicted in FIG. 4B. In embodiments, only a small amount of pressure is placed on the intermediate glass-based article to form the intermediate glass-based article in the intermediate mold. By not placing too much pressure on the intermediate glass-based article to form the intermediate glass-based article in the intermediate mold, wrinkling, warping, and other damage may be mitigated or prevented during the forming of the intermediate glass-based article in the intermediate mold.

In embodiments where the intermediate glass-based article is formed in the intermediate mold by vacuum pressing, a vacuum is formed that holds the intermediate glass-based article to the intermediate mold, such as by providing channels in the intermediate mold that allows a vacuum to t be formed that holds the intermediate glass-based article to the intermediate mold. The vacuum may be formed by any suitable vacuum apparatus. In embodiments, the vacuum formed between the intermediate glass-based article and the intermediate mold is not a strong vacuum. By using a weak vacuum, wrinkling, warping, and other damage may be mitigated or prevented during the forming of the intermediate glass-based article in the intermediate mold.

In embodiments where the intermediate glass-based article is formed in the intermediate mold by differential pressure forming, a pressure differential is formed between the intermediate glass-based article and the intermediate mold, such that a pressure in a region between the intermediate glass-based article and the intermediate mold is lower than a pressure outside intermediate glass-based article. This may, in embodiments, be achieved by securing or sealing the intermediate glass-based article to the intermediate mold and increasing the pressure outside of the intermediate glass-based article by any suitable pumping mechanism. In embodiments, the pressure differential is not a large pressure differential. By using a small pressure differential, wrinkling, warping, and other damage may be mitigated or prevented during the introduction of the intermediate glass-based article into the intermediate mold.

After the intermediate glass-based article is formed in the intermediate mold, the intermediate glass-based article is cooled to form a multi-dimensional glass-based article. The cooling of the intermediate glass-based article into the multi-dimensional glass-based article may be a cooling to ambient temperature or may be a cooling to a temperature above ambient temperature. However, according to one or more embodiments, the intermediate glass-based article is cooled to a temperature such that the viscosity of the intermediate glass-based article rises and the intermediate glass-based article is no longer easily formable. In embodiments, the intermediate glass-based article is cooled by active cooling, such as by flowing cold gas over the intermediate glass-based article or introducing a cool liquid to the intermediate glass-based article. The flowing of cold gas or quenching with a cool liquid may continue until the intermediate glass-based article reaches the desired temperature. In one or more embodiments the intermediate glass-based article is cooled by passive cooling where the intermediate glass-based article is allowed to cool by exposing the intermediate glass-based article to ambient temperatures.

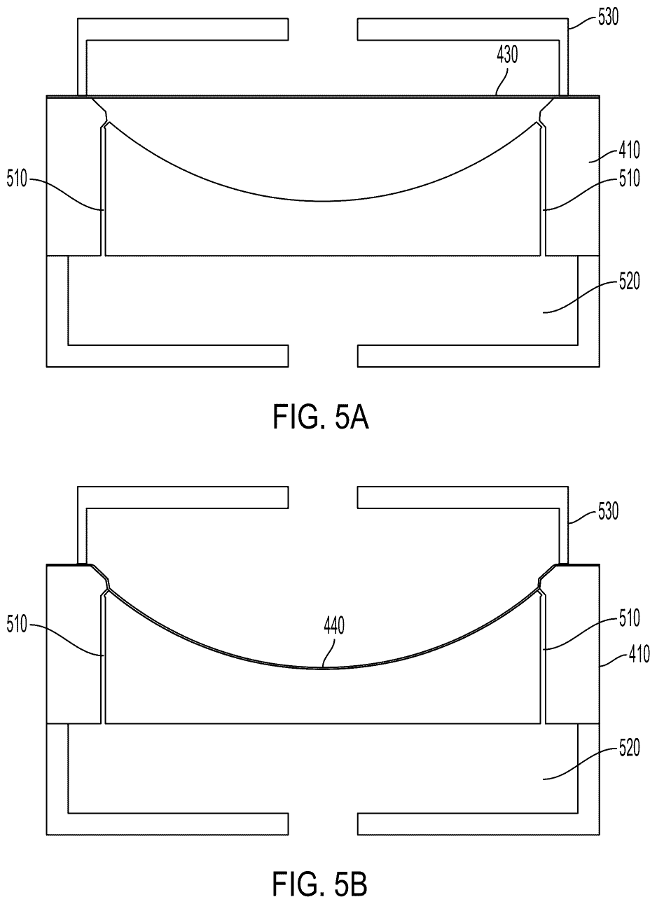

In one or more embodiments, placing the two-dimensional glass-based preform 430 at the opening of the preform mold 410 comprises holding at least a portion of the perimeter of the two-dimensional glass-based preform 430 to the preform mold. Such embodiments will now be described with reference to FIG. 5A and FIG. 5B. The preform mold 410 depicted in FIG. 5A and FIG. 5B includes two evacuation slots 510 that are fluidly connected to a vacuum chamber 520 positioned below the preform mold 410. When a vacuum is formed in the vacuum chamber 520, gases in the evacuation slots 510 are removed causing a vacuum to be formed between the two-dimensional glass-based preform 430 and the preform mold 410. This can cause the two-dimensional glass-based preform 430 to sag into the preform mold 410. In embodiments, a pressure differential (higher pressure above the two-dimensional glass-based preform 430 in FIG. 5A) is applied to the glass. This pressure differential introduces the two-dimensional glass-based preform 430 to the preform mold 410. The larger the pressure differential the higher the forming force. A larger pressure differential allows for forming at lower temperatures (higher viscosities), which is advantageous for mitigating forming defects. Hot gas (typically N₂ or Ar) is used to create the high pressure region above the two-dimensional glass-based preform 430 (this could also be liquid). The evacuation slots 510 are used to evacuate the volume under the two-dimensional glass-based preform 430. This could also be accomplished if the mold is made from a porous material (metal, graphite, or ceramic) or a porous insert. In embodiments, the pressure above the two-dimensional glass-based preform 430 may be greater than 1 atmosphere and the pressure below the two-dimensional glass-based preform 430 may be 1 atmosphere, the pressure above the two-dimensional glass-based preform 430 may be greater than 1 atmosphere and the pressure below the two-dimensional glass-based preform 430 may be less than 1 atmosphere, or the pressure above the two-dimensional glass-based preform 430 may be 1 atmosphere and the pressure below the two-dimensional glass-based preform 430 may be less than 1 atmosphere.

As mentioned above, the two-dimensional glass-based preform 430 may drag on the preform mold 410 as the two-dimensional glass-based preform 430 sags into the preform mold 410. To prevent this dragging, a clamp 530 is positioned on the two-dimensional glass-based preform 430 that has been heated to the first temperature to hold the two-dimensional glass-based preform 430 to the preform mold 410. In embodiments, the clamp 530 is positioned so that it is in physical contact with a portion of the perimeter of the two-dimensional glass-based preform 430 to hold the two-dimensional glass-based preform 430 to the preform mold 410 while the two-dimensional glass-based preform 430 sags into the preform mold 410. The force applied to the portion of the perimeter of the two-dimensional glass-based preform 430 that is in contact with the clamp 530 is, in embodiments, just enough to hold the two-dimensional glass-based preform 430 to the preform mold 410 during sagging without applying too much pressure that could damage the two-dimensional glass-based preform 430. Although FIG. 5 depicts a system where vacuum sagging is used to introduce the two-dimensional glass-based preform 430 into the preform mold 410, it should be understood that the clamp 530 may be used when other methods of sagging, such as gravity sagging, differential pressure sagging, and pressing are used to introduce the two-dimensional glass-based preform 430 to the preform mold 410. FIG. 5B depicts the glass-based preform 440 in the preform mold 410 after a vacuum has been formed and shows the glass-based preform 440 with a global bow that generally mimics the shape of the preform mold 410.

After the two-dimensional glass-based preform 430 has sagged into the preform mold 410 to form a glass-based preform 440, the clamp 530 may be removed. In embodiments, the clamp 530 may be removed from the glass-based preform 440 before cooling, after cooling, or during cooling of the glass-based preform 440. Subsequent to removing the clamp 530, and cooling the glass-based preform 440 to form the intermediate glass-based article, the intermediate glass-based 450 article may be placed into the intermediate mold.

Although FIG. 5A and FIG. 5B depict a clamp 530 holding the two-dimensional glass-based preform 430 to the preform mold 410, in embodiments, the two-dimensional glass-based preform 430 may be held to the preform mold 410 by an adhesive, a vacuum, or suction. In embodiments, where an adhesive is used to hold the two-dimensional glass-based preform 430 to the preform mold 410, the adhesive is applied to the portion of the perimeter of the two-dimensional glass-based preform 430 that is to be held to the preform mold 410. The adhesive holds the two-dimensional glass-based preform 430 to the preform mold 410 during the introduction of the two-dimensional glass-based preform 430 into the preform mold. After the two-dimensional glass-based preform 430 is introduced into the preform mold 410, the adhesive may be removed, such as by physical or chemical pealing or the like and, after the glass-based preform 440 is cooled to form the intermediate glass-based article 450, the intermediate glass-based article 450 may be placed in the intermediate mold. The adhesive may be any adhesive that can withstand the first temperature without losing adequate adhesion, but that can be removed without damaging the glass-based preform or the intermediate glass-based article 450.

In embodiments where a vacuum or suction is used to hold the two-dimensional glass-based preform 430 to the preform mold 410, a localized vacuum or suction is provided to the portion of the perimeter of the two-dimensional glass-based preform 430 that is to be held to the preform mold 410. The vacuum or suction is maintained to hold the two-dimensional glass-based preform 430 to the preform mold 410 during the introduction of the two-dimensional glass-based preform 430 into the preform mold. After the two-dimensional glass-based preform 430 is introduced into the preform mold 410 to form the glass-based preform 440, the vacuum or suction may be removed, such as by turning off a pump or otherwise returning the vacuum or suction to atmospheric pressure. The vacuum or suction may be removed before, during, or after the glass-based preform 440 is cooled to form the intermediate glass-based article 450, and the intermediate glass-based article 450 may be placed in the intermediate mold after the vacuum or suction has been removed. The vacuum or suction can be applied by any suitable apparatus, such as vacuum pumps and suction cups, etc.

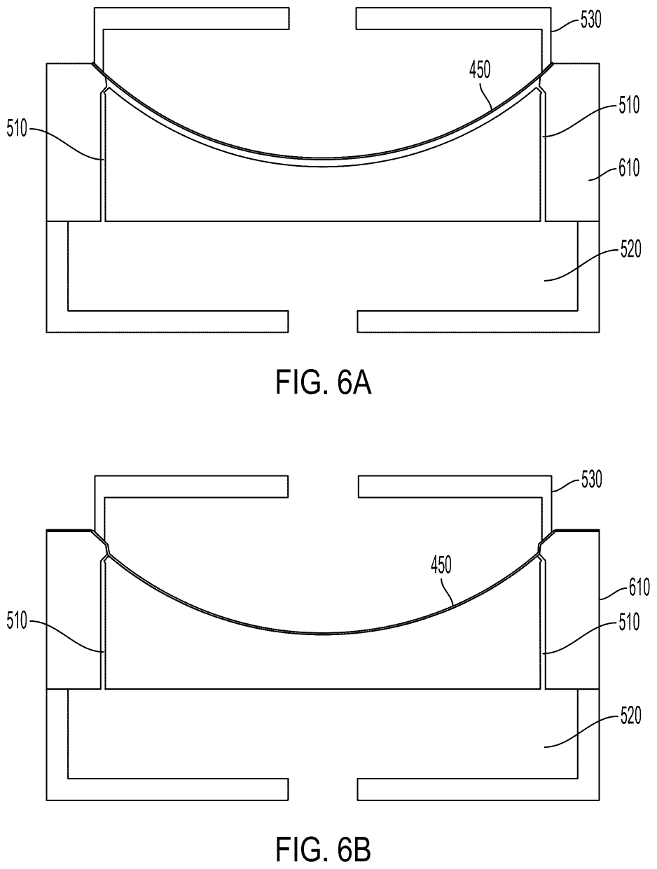

In one or more embodiments, placing the intermediate glass-based article 450 at the opening of the intermediate mold comprises holding at least a portion of the perimeter of the intermediate glass-based article 450 to the intermediate mold. Such embodiments will now be described with reference to FIG. 6A and FIG. 6B. The intermediate mold 610 depicted in FIG. 6A and FIG. 6B includes two evacuation slots 510 that are fluidly connected to a vacuum chamber 520 positioned below the intermediate mold 610. When a vacuum is formed in the vacuum chamber 520, gases in the evacuation slots 510 are removed causing a vacuum to be formed between the intermediate glass-based article 450 and the intermediate mold 610. The global bow of the intermediate glass-based article 450 generally mimics the shape of the intermediate mold 610 such that there is a small gap between the intermediate glass-based article 450 and the intermediate mold 610. When a vacuum is formed, the intermediate glass-based article 450 is formed in the intermediate mold 610. In embodiments, a pressure differential (higher pressure above the intermediate glass-based article 450 in FIG. 6A) is applied to the intermediate glass-based article 450. This pressure differential forms the intermediate glass-based article 450 to the intermediate mold 610. The larger the pressure differential the higher the forming force. A larger pressure differential allows for forming at lower temperatures (higher viscosities), which is advantageous for mitigating forming defects. Hot gas (such as N₂ or Ar) is used to create the high pressure region above the intermediate glass-based article 450 (this could also be liquid). The evacuation slots 510 are used to evacuate the volume between the intermediate glass-based article 450 and the intermediate mold 610. This could also be accomplished if the intermediate mold 610 is made from a porous material (metal, graphite, or ceramic) or a porous insert. In embodiments, the pressure above the intermediate glass-based article 450 may be greater than 1 atmosphere and the pressure below the intermediate glass-based article 450 may be 1 atmosphere, the pressure above the intermediate glass-based article 450 may be greater than 1 atmosphere and the pressure below the intermediate glass-based article 450 may be less than 1 atmosphere, or the pressure above the intermediate glass-based article 450 may be 1 atmosphere and the pressure below the intermediate glass-based article 450 may be less than 1 atmosphere.

As mentioned above, the intermediate glass-based article 450 may drag on the intermediate mold 610 as the intermediate glass-based article 450 is formed in the intermediate mold 610. To prevent this dragging, a clamp 530 is positioned on the intermediate glass-based article 450 that has been heated to the first temperature to hold the intermediate glass-based article 450 to the intermediate mold 610. In embodiments, the clamp 530 is positioned so that it is in physical contact with a portion of the perimeter of the intermediate glass-based article 450 to hold the intermediate glass-based article 450 to the intermediate mold 610 while the intermediate glass-based article 450 is formed in the intermediate mold 610. The force applied to the portion of the perimeter of the intermediate glass-based article 450 that is in contact with the clamp 530 is, in embodiments, just enough to hold the intermediate glass-based article 450 to the intermediate mold 610 during forming without applying too much pressure that could damage the intermediate glass-based article 450. Although FIG. 6A and FIG. 6B depicts a system where vacuum forming is used to form the intermediate glass-based article 450 in the intermediate mold 610, it should be understood that the clamp 530 may be used when other methods of forming, such as differential pressure forming and press forming, which is discussed in more detail below. FIG. 6B depicts the intermediate glass-based article 450 in the intermediate mold 610 after a vacuum has been formed and shows the intermediate glass-based article 450 molded to the shape of the intermediate mold 610.

After the intermediate glass-based article 450 is formed in the intermediate mold 610, the clamp 530 may be removed. In embodiments, the clamp 530 may be removed from the intermediate glass-based article 450 before cooling, after cooling, or during cooling of the intermediate glass-based article 450 to form the multi-dimensional glass-based article.

Although FIG. 6A and FIG. 6B depict a clamp 530 holding the intermediate glass-based article 450 to the intermediate mold 610, in embodiments, the intermediate glass-based article 450 may be held to the intermediate mold 610 by an adhesive, a vacuum, or suction. In embodiments, where an adhesive is used to hold the intermediate glass-based article 450 to the intermediate mold 610, the adhesive is applied to the portion of the perimeter of the intermediate glass-based article 450 that is to be held to the intermediate mold 610. The adhesive holds the intermediate glass-based article 450 to the intermediate mold 610 during the forming of the intermediate glass-based article 450 in the intermediate mold 610. After the intermediate glass-based article 450 is formed in the intermediate mold 610, the adhesive may be removed, such as by physical or chemical pealing or the like. The adhesive may be removed before, during, or after the intermediate glass-based article 450 is cooled to form the multi-dimensional glass-based article and the multi-dimensional glass-based article may be removed from the intermediate mold 610. The adhesive may be any adhesive that can withstand the second temperature without losing adequate adhesion, but that can be removed without damaging the intermediate glass-based article 450 or the multi-dimensional glass-based article.

In embodiments where a vacuum or suction is used to hold the intermediate glass-based article 450 to the intermediate mold 610, a localized vacuum or suction is provided to the portion of the perimeter of the intermediate glass-based article 450 that is to be held to the intermediate mold 610. The vacuum or suction is maintained to hold the intermediate mold 610 to the intermediate mold 610 during the forming of the intermediate mold 610 in the intermediate mold 610. After the intermediate glass-based article 450 is formed in the intermediate mold 610, the vacuum or suction may be removed, such as by turning off a pump or otherwise returning the vacuum or suction to atmospheric pressure. The vacuum or suction can be removed before, during, or after cooling the intermediate glass-based article 450 to form the multi-dimensional glass-based article. After the vacuum or suction has been removed and the intermediate glass-based article 450 has cooled to form the multi-dimensional glass-based article, the multi-dimensional glass-based article may be removed from the intermediate mold 610. The vacuum or suction can be applied by any suitable apparatus, such as vacuum pumps and suction cups, etc.

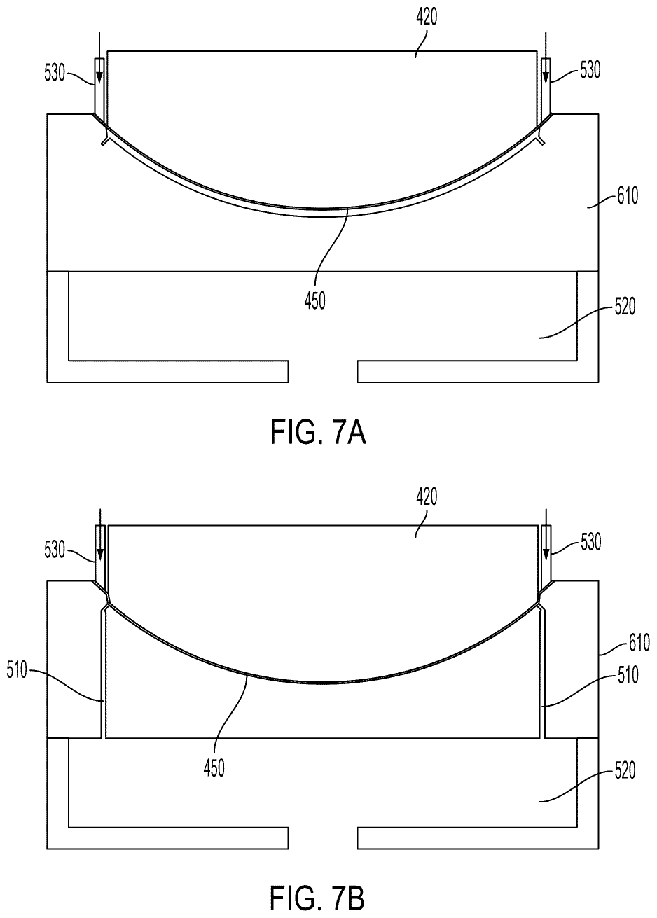

In one or more embodiments, the intermediate glass-based article 450 may be held to the intermediate mold 610 while forming the intermediate glass-based article 450 in the intermediate mold 610 by pressing. Such embodiments will now be described with reference to FIG. 7A and FIG. 7B. The global bow of the intermediate glass-based article 450 generally mimics the shape of the intermediate mold 610 such that there is a small gap between the intermediate glass-based article 450 and the intermediate mold 610, as shown in FIG. 7A. When a mold press 420 is moved toward the intermediate glass-based article 450, the intermediate glass-based article 450 is formed in the intermediate mold 610 by pressing the heated intermediate glass-based article 450 against the intermediate mold 610, as shown in FIG. 7B.

As mentioned above, the intermediate glass-based article 450 may drag on the intermediate mold 610 as the intermediate glass-based article 450 is formed in intermediate mold 610. To prevent this dragging, a clamp 530 is positioned on the intermediate glass-based article 450 that has been heated to the first temperature to hold the intermediate glass-based article 450 to the intermediate mold 610. In embodiments, the clamp 530 is positioned so that it is in physical contact with a portion of the perimeter of the intermediate glass-based article 450 to hold the intermediate glass-based article 450 to the intermediate mold 610 while the intermediate glass-based article 450 is pressed in the intermediate mold 610 by the mold press 420. The force applied to the portion of the perimeter of the intermediate glass-based article 450 that is in contact with the clamp 530 is, in embodiments, just enough to hold the intermediate glass-based article 450 to the intermediate mold 610 during forming without applying too much pressure that could damage the intermediate glass-based article 450.

After the intermediate glass-based article 450 is formed in the intermediate mold 610, the clamp 530 may be removed. In embodiments, the clamp 530 may be removed from the intermediate glass-based article 450 before cooling, after cooling, or during cooling of the intermediate glass-based article 450.

Although FIG. 7A and FIG. 7B depict a clamp 530 holding the intermediate glass-based article 450 to the intermediate mold 610, in embodiments, the intermediate glass-based article 450 may be held to the intermediate mold 610 by an adhesive, a vacuum, or suction. In embodiments, where an adhesive is used to hold the intermediate glass-based article 450 to the intermediate mold 610, the adhesive is applied to the portion of the perimeter of the intermediate glass-based article 450 that is to be held to the intermediate mold 610. The adhesive holds the intermediate glass-based article 450 to the intermediate mold 610 during the forming of the intermediate glass-based article 450 in the intermediate mold 610. After the intermediate glass-based article 450 is formed in the intermediate mold 610, the adhesive may be removed, such as by physical or chemical pealing or the like. The adhesive may be removed before, during, or after the intermediate glass-based article 450 is cooled to form the multi-dimensional glass-based article and the multi-dimensional glass-based article may be removed from the intermediate mold 610. The adhesive may be any adhesive that can withstand the second temperature without losing adequate adhesion, but that can be removed without damaging the intermediate glass-based article 450 or the multi-dimensional glass-based article.

In embodiments where a vacuum or suction is used to hold the intermediate glass-based article 450 to the intermediate mold 610, a localized vacuum or suction is provided to the portion of the perimeter of the intermediate glass-based article 450 that is to be held to the intermediate mold 610. The vacuum or suction is maintained to hold the intermediate mold 610 to the intermediate mold 610 during the forming of the intermediate mold 610 in the intermediate mold 610. After the intermediate glass-based article 450 is formed in the intermediate mold 610, the vacuum or suction may be removed, such as by turning off a pump or otherwise returning the vacuum or suction to atmospheric pressure. The vacuum or suction can be removed before, during, or after cooling the intermediate glass-based article 450 to form the multi-dimensional glass-based article. After the vacuum or suction has been removed and the intermediate glass-based article 450 has cooled to form the multi-dimensional glass-based article, the multi-dimensional glass-based article may be removed from the intermediate mold 610. The vacuum or suction can be applied by any suitable apparatus, such as vacuum pumps and suction cups, etc.

Embodiments disclosed hereinabove include holding a portion of the two-dimensional glass-based preform 430 to the preform mold 410 and include holding a portion of the intermediate glass-based article 450 to the intermediate mold 610. It should be understood that these embodiments may be used together or separately. For instance, in embodiments: the two-dimensional glass-based preform 430 may be held to the preform mold 410 and the intermediate glass-based article 450 may not be held to the intermediate mold 610; the two-dimensional glass-based preform 430 may be held to the preform mold 410 and the intermediate glass-based article 450 may be held to the intermediate mold 610; the two-dimensional glass-based preform 430 may not be held to the preform mold 410 and the intermediate glass-based article 450 may be held to the intermediate mold 610; or the two-dimensional glass-based preform 430 may not be held to the preform mold 410 and the intermediate glass-based article 450 may not be held to the intermediate mold 610.

Single stage processing that comprises holding a two-dimensional glass-based preform to a mold, such as by clamping or the like, will work to form a multi-dimensional glass-based article, but there will likely be severe thinning associated with this single stage processing because the two-dimensional glass-based preform has to significantly stretch to conform to the cavity in the preform mold. However, by using a two-stage process, such as processes disclosed and described herein where an intermediate glass-based article 450 is generated by a first stage and then the intermediate glass-based article 450 is further molded or formed into multi-dimensional glass-based article in a second stage, there is less thinning because the two-dimensional glass-based preform is not required to stretch as significantly as in a single-stage process. The calculations provide below show this point.

TABLE 1
Two-Stage Process

| Surface Area (mm²) | | Area Ratio | | |
|---|---|---|---|---|
| Post 1^{st} stage/ | | Post 2^{nd} | Preform | Theoretical uniform |
| pre 2^{nd} stage | Post 2^{nd} | stage/post | thickness | part final thickness |
| part | stage part | 1^{st} stage | (mm) | (mm) |
| 19638.4 | 20570.3 | 1.05 | 1.0 | 0.955 |

TABLE 2
Single-Stage process

| Surface Area (mm²) | | Area Ratio | | |
|---|---|---|---|---|
| Post 1^{st} stage/ | | Post 2^{nd} | Preform | Theoretical uniform |
| pre 2^{nd} stage | Post 2^{nd} | stage/post | thickness | part final thickness |
| part | stage part | 1^{st} stage | (mm) | (mm) |
| 25497.1 | 39744.9 | 1.56 | 1.0 | 0.642 |

Table 1 above show the theoretical thickness of a part formed with a two-stage process and edge holding (clamping), and Table 2 shows the theoretical thickness of a part formed with a single-stage process with edge holding (clamping). Uniform thickness distribution across the two-dimensional glass-based preform is used for the calculations in Table 1 and Table 2. In addition, a thickness of 1 mm is used for the calculations in Table 1 and Table 2. The final multi-dimensional glass-based article formed by two-stage process has a thickness of 0.955 mm. The final multi-dimensional glass-based article made with a single-stage process has a thickness that is 0.642 mm. Accordingly, the multi-dimensional glass-based article formed by a two-stage process with edge holding (clamping) has approximately eight times less thinning than a multi-dimensional glass-based article formed by a single-stage process with edge holding (clamping). This shows a distinct advantage of a two-stage process with edge holding versus a single-stage process with edge holding.

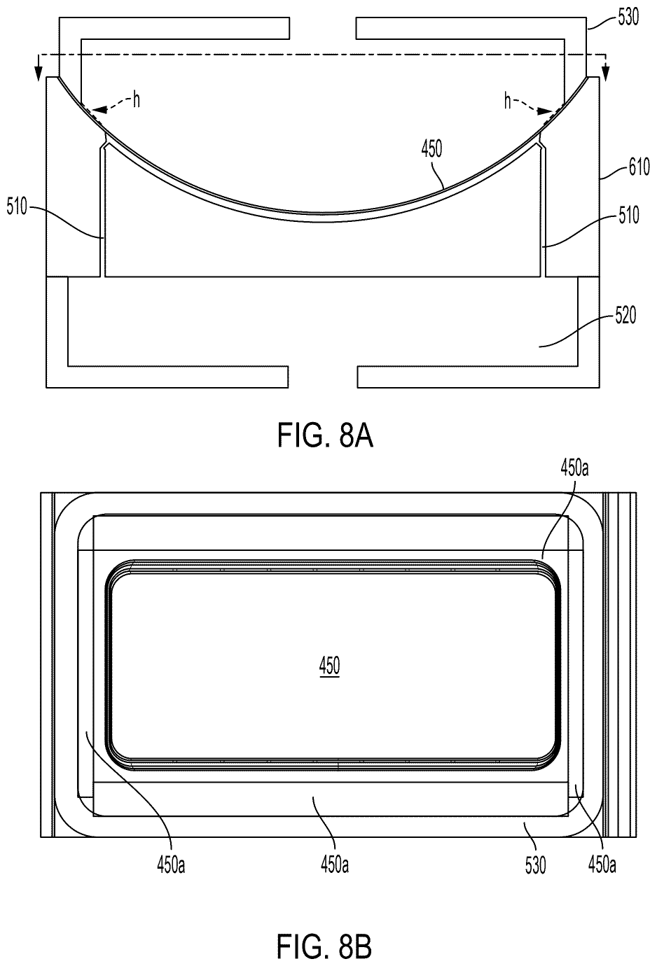

To further reduce the thinning of the two-dimensional glass-based preform or the intermediate glass-based article 450 when holding the edges of the two-dimensional glass-based preform or the intermediate glass-based article 450, such as by clamping, during forming, the edges of the two-dimensional glass-based preform or the intermediate glass-based article 450 that are being held may be heated to a temperature that is greater than the temperature of the remainder of the two-dimensional glass-based preform or intermediate glass-based article 450. This process will be described in more detail with reference to FIG. 8A and FIG. 8B. FIG. 8A is a side view of intermediate glass-based article 450 present in an intermediate mold 610 according to embodiments; however, it should be understood that the description provided here equally applies to a two-dimensional glass-based preform at the opening of a preform mold. In FIG. 8A, a portion of the perimeter (450a) of the intermediate glass-based article 450 (also referred to as edges of the intermediate glass-based article 450) are held by a clamp 530. In embodiments, the portion of the perimeter 450a of the intermediate glass-based article 450 adjacent to the clamp 530 are heated (shown by h in FIG. 8A and FIG. 8B) to a temperature that is greater than the temperature to which the remainder of the intermediate glass-based article 450 is heated. Accordingly, the viscosity of the intermediate glass-based article 450 is lower at the portion of the perimeter 450a of the intermediate glass-based article 450 that is adjacent to the clamp 530 than the viscosity in the remainder of the intermediate glass-based article 450. This allows the portion of the perimeter 450a of the intermediate glass-based article 450 that is adjacent to the clamp 530, which is generally not the target quality area of the intermediate glass-based article 450, to stretch more than the remainder of the intermediate glass-based article 450, which may include the target quality area of the intermediate glass-based article 450. It should be understood that the heat may be provided by any suitable mechanism, such as localized radiant, conductive, or focused energy beam heating.

FIG. 8B is a top view of the intermediate glass-based article 450 showing the portions of the perimeter 450a of the intermediate glass-based article 450 being contacted by the clamp 530, and the areas adjacent to the clamp being heated to a temperature that is greater than the temperature of the remainder of the intermediate glass-based article 450. As noted above, this will cause the viscosity of the portions of the perimeter 450a of the intermediate glass-based article 450 to be lower than the viscosity of the remainder of the glass based article, which will allow the portions of the perimeter 450a of the intermediate glass-based article 450 to stretch more than the remainder of the intermediate glass-based article 450. After the multi-dimensional glass-based article is formed, the portions of the perimeter 450a of the multi-dimensional glass-based article that was subject to additional stretching may be removed and discarded.

Advantages of the two-stage processes disclosed and described herein will not be provided in detail. By using a preform mold and an intermediate mold in a two-stage process, alignment of the intermediate glass-based article in the intermediate mold can be improved because the intermediate glass-based article has a general bow that is similar to the shape of the intermediate mold, and the intermediate glass-based article is cool and can be aligned in the intermediate mold before it is heated to the second temperature, which can improve the alignment of the intermediate glass-based article in the intermediate mold. This effect is particularly significant when the multi-dimensional glass-based article has a significant curvature with a vertical drop that is greater than or equal to 25 mm and less than or equal to 70 mm, such as greater than or equal to 30 mm and less than or equal to 65 mm, greater than or equal to 35 mm and less than or equal to 60 mm, greater than or equal to 40 mm and less than or equal to 55 mm, or greater than or equal to 45 mm and less than or equal to 50 mm.

As mentioned above, using a two-stage process can reduce the distance that the intermediate glass-based article will drag on the edge of the molds by having an intermediate glass-based article that has a general bow that is similar in geometry to the intermediate mold. By having this similar geometry, the intermediate glass-based article can sit in the cavity of the intermediate mold 610 before final forming, which limits the distance that the intermediate glass-based article will drag on the intermediate mold, thus there is significantly less dragging on the intermediate glass-based article before final forming into a multi-dimensional glass-based article. Moreover, using a two-stage process, the overall mold stack height and stroke needed for form the multi-dimensional glass-based article from the intermediate glass-based article is reduced by the amount of the sagging or pressing of the two-dimensional intermediate glass-based article into the preform mold.

In addition to the above, by having a two-stage process with two distinct thermal cycles allows forming glass-ceramics with distinct characteristics. For instance, the first stage where the two-dimensional glass-based preform is heated to a first temperature may be used to nucleate the two-dimensional glass-based preform, and the second stage where the intermediate glass-based article is heated to the second temperature can be used for crystal growth of the nucleated intermediate glass-based article. For a two-process, lower maximum forming temperature has been demonstrated for both glass and glass ceramic forming. Two-stage processes for glass can have more than a 30° C. lower maximum forming temperature as compared to single stage forming. Glass-ceramic 3D shaping can have more than 15° C. lower maximum forming temperatures as compared to single stage forming.

Various aspects of embodiments will now be provided.

A first aspect is a method for forming a multi-dimensional glass-based article, the method comprising: placing a two-dimensional glass-based preform at an opening of a preform mold; heating the two-dimensional glass-based preform to a first temperature; introducing the two-dimensional glass-based preform into a cavity of the preform mold to form a glass-based preform; cooling the glass-based preform to form an intermediate glass-based article; placing the intermediate glass-based article into an intermediate mold; heating the intermediate glass-based article to a second temperature; forming the intermediate glass-based article in the intermediate mold; cooling the intermediate glass-based article to form the multi-dimensional glass-based article.

A second aspect includes the method of the first aspect, wherein the preform mold and the intermediate mold are different molds.

A third aspect includes the method of the first aspect, wherein the preform mold and the intermediate mold are the same mold.

A fourth aspect includes the method of any one of the first to third aspects, wherein heating the two-dimensional glass-based preform to the first temperature comprises heating the two-dimensional glass-based preform to a temperature such that the two-dimensional glass-based preform has a viscosity that is greater than or equal to 10⁹ poise and less than or equal to 10¹¹ poise.

A fifth aspect includes the method of any one of the first to fourth aspects, wherein heating the two-dimensional glass-based preform to the first temperature comprises heating the glass-based preform to a temperature such that the two-dimensional glass-based preform has a viscosity that is about 10¹⁰ poise.

A sixth aspect includes the method of any one of the first to fifth aspects, wherein introducing the two-dimensional glass-based preform into the preform mold comprises gravity sagging a heated two-dimensional glass-based preform into the preform mold.

A seventh aspect includes the method of any one of the first to fifth aspects, wherein introducing the two-dimensional glass-based preform into the preform mold comprises pressing, vacuum sagging, or differential pressure sagging a heated two-dimensional glass-based preform into the preform mold.

An eighth aspect includes the method of any one of the first to seventh aspects, wherein cooling the glass-based preform comprises active cooling.

A ninth aspect includes the method of any one of the first to eighth aspects, wherein placing the intermediate glass-based article into the intermediate mold comprises placing the intermediate glass-based article into a mold that is different from the preform mold.

A tenth aspect includes the method of any one of the first to eighth aspects, wherein placing the intermediate glass-based article into the intermediate mold comprises keeping the intermediate glass-based article within the preform mold.

An eleventh aspect includes the method of any one of the first to tenth aspects, wherein heating the intermediate glass-based article to the second temperature comprises heating the intermediate glass-based article to a temperature such that the intermediate glass-based article has a viscosity that is greater than or equal to 10⁹ poise and less than or equal to 10¹¹ poise.

A twelfth aspect includes the method of any one of the first to eleventh aspects, wherein heating the intermediate glass-based article to the second temperature comprises heating the intermediate glass-based article to a temperature such that the intermediate glass-based article has a viscosity that is about 10¹⁰ poise.

A thirteenth aspect includes the method of any one of the first to twelfth aspects, wherein the first temperature is less than the second temperature.

A fourteenth aspect includes the method of any one of the first to thirteenth aspects, wherein forming the intermediate glass-based article in the intermediate mold comprises pressing the intermediate glass-based article into the intermediate mold.

A fifteenth aspect includes the method of any one of the first to thirteenth aspects, wherein forming the intermediate glass-based article in the intermediate mold comprises vacuum pressing the intermediate glass-based article into the intermediate mold.

A sixteenth aspect includes the method of any one of the first to thirteenth aspects, wherein forming the intermediate glass-based article in the intermediate mold comprises differential pressure forming the intermediate glass-based article into the intermediate mold.

A seventeenth aspect includes the method of any one of the first to sixteenth aspects, wherein cooling the intermediate glass-based article comprises active cooling.

An eighteenth aspect includes the method of any one of the first to seventeenth aspects, wherein placing the two-dimensional glass-based preform at the opening of the preform mold comprises holding at least a portion of a perimeter of the two-dimensional glass-based preform to the preform mold.

A nineteenth aspect includes the method of any one of the first to eighteenth aspects, wherein the two-dimensional glass-based preform is held to the preform mold by a clamp.

A twentieth aspect includes the method of any one of the first to eighteenth aspects, wherein the two-dimensional glass-based preform is held to the preform mold by an adhesive, a vacuum, or suction.

A twenty-first aspect includes the method of any one of the eighteenth to twentieth aspects, wherein the at least a portion of the perimeter of the two-dimensional glass-based preform that is held to the preform mold is heated to a temperature that is greater than the first temperature.

A twenty-second aspect includes the method of any one of the first to twenty-first aspects, wherein forming the intermediate glass-based article into the intermediate mold comprises holding at least a portion of a perimeter of the intermediate glass-based article to the intermediate mold.

A twenty-third aspect includes the method of any one of the first to twenty-second aspects, wherein the intermediate glass-based article is held to the intermediate mold by a clamp.

A twenty-fourth aspect includes the method of any one of the first to twenty-second aspects, wherein the intermediate glass-based article is held to the intermediate mold by an adhesive, a vacuum, or suction.

A twenty-fifth aspect includes the method of any one of the twenty second to twenty-fourth aspects, wherein the at least a portion of the perimeter of the intermediate glass-based article that is held to the intermediate mold is heated to a temperature that is greater than the second temperature.

A twenty-sixth aspect is a method for forming a multi-dimensional glass-based article, the method comprising: placing a two-dimensional glass-based preform at an opening of a preform mold; heating the two-dimensional glass-based preform to a first temperature; sagging the two-dimensional glass-based preform into the preform mold forming a glass-based preform; cooling the glass-based preform to form an intermediate glass-based article; placing the intermediate glass-based article into an intermediate mold; holding at least a portion of a perimeter of the intermediate glass-based article to the intermediate mold; heating the intermediate glass-based article to a second temperature; forming the intermediate glass-based article in the intermediate mold; cooling the intermediate glass-based article to form the multi-dimensional glass-based article.

A twenty-seventh aspect includes the method of the twenty-sixth aspect, wherein the preform mold and the intermediate mold are different molds.

A twenty-eighth aspect includes the method of the twenty-sixth aspect, wherein the preform mold and the intermediate mold are the same mold.

A twenty-ninth aspect includes the method of any one of the twenty-sixth to twenty-eighth aspects, wherein the intermediate glass-based article is held to the intermediate mold by a clamp.

A thirtieth aspect includes the method of any one of the twenty-sixth to twenty-eighth aspects, wherein the intermediate glass-based article is held to the intermediate mold by a vacuum.

A thirty-first aspect includes the method of any one of the twenty-sixth to twenty-eighth aspects, wherein the intermediate glass-based article is held to the intermediate mold by an adhesive.

A thirty-second aspect includes the method of any one of the twenty-sixth to thirty-first aspects, wherein the at least a portion of the perimeter of the intermediate glass-based article that is held to the intermediate mold is heated to a temperature that is greater than the second temperature.

A thirty-third aspect includes the method of any one of the twenty-sixth to thirty-second aspects, wherein heating the two-dimensional glass-based preform to the first temperature comprises heating the two-dimensional glass-based preform to a temperature such that the two-dimensional glass-based preform has a viscosity that is greater than or equal to 10⁹ poise and less than or equal to 10¹¹ poise.

A thirty-fourth aspect includes the method of any one of the twenty-sixth to thirty-third aspects, wherein heating the two-dimensional glass-based preform to the first temperature comprises heating the two-dimensional glass-based preform to a temperature such that the two-dimensional glass-based preform has a viscosity that is about 10¹⁰ poise.

A thirty-fifth aspect includes the method of any one of the twenty-sixth to thirty-fourth aspects, wherein sagging the two-dimensional glass-based preform into the preform mold comprises gravity sagging a heated two-dimensional glass-based preform into the preform mold.

A thirty-sixth aspect includes the method of any one of the twenty-sixth to thirty-fourth aspects, wherein sagging the two-dimensional glass-based preform into the preform mold comprises vacuum sagging or differential pressure sagging a heated two-dimensional glass-based preform into the preform mold.

A thirty-seventh aspect includes the method of any one of the twenty-sixth to thirty-sixth aspects, wherein cooling the glass-based preform comprises active cooling.

A thirty-eighth aspect includes the method of any one of the twenty-sixth to thirty-seventh aspects, wherein placing the intermediate glass-based article into the intermediate mold comprises placing the intermediate glass-based article into a mold that is different from the preform mold.

A thirty-ninth aspect includes the method of any one of the twenty-sixth to thirty-seventh aspects, wherein placing the intermediate glass-based article into the intermediate mold comprises keeping the intermediate glass-based article within the preform mold.

A fortieth aspect includes the method of any one of the twenty-sixth to thirty-ninth aspects, wherein heating the intermediate glass-based article to the second temperature comprises heating the intermediate glass-based article to a temperature such that the intermediate glass-based article has a viscosity that is greater than or equal to 10⁹ poise and less than or equal to 10¹¹ poise.

A forty-first aspect includes the method of any one of the twenty-sixth to fortieth aspects, wherein heating the intermediate glass-based article to the second temperature comprises heating the intermediate glass-based article to a temperature such that the intermediate glass-based article has a viscosity that is about 10¹⁰ poise.

A forty-second aspect includes the method of any one of the twenty-sixth to forty-first aspects, wherein the first temperature is less than the second temperature.

A forty-third aspect includes the method of any one of twenty-sixth to forty-second aspects, wherein forming the intermediate glass-based article in the intermediate mold comprises pressing the intermediate glass-based article into the intermediate mold.

A forty-second aspect includes the method of any one of the twenty-sixth to forty-second aspects, wherein forming the intermediate glass-based article in the intermediate mold comprises vacuum pressing the intermediate glass-based article into the intermediate mold.

A forty-fifth aspect includes the method of any one of twenty-sixth to forty-second aspects, wherein forming the intermediate glass-based article in the intermediate mold comprises differential pressure forming the intermediate glass-based article into the intermediate mold.

A forty-sixth aspect includes the method of any one of the twenty-sixth to forty-firth aspects, wherein cooling the intermediate glass-based article comprises active cooling.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for forming a multi-dimensional glass-based article, the method comprising:
placing a two-dimensional glass-based preform at an opening of a preform mold;
heating the two-dimensional glass-based preform to a first temperature;
introducing the two-dimensional glass-based preform into a cavity of the preform mold to form a glass-based preform;
cooling the glass-based preform to form an intermediate glass-based article;
placing the intermediate glass-based article into an intermediate mold;
heating the intermediate glass-based article to a second temperature;
forming the intermediate glass-based article in the intermediate mold; and
cooling the intermediate glass-based article to form the multi-dimensional glass-based article.

2. The method of claim 1, wherein the preform mold and the intermediate mold are different molds.

3. The method of claim 1, wherein the preform mold and the intermediate mold are the same mold.

4. The method of claim 1, wherein heating the two-dimensional glass-based preform to the first temperature comprises heating the two-dimensional glass-based preform to a temperature such that the two-dimensional glass-based preform has a viscosity that is greater than or equal to 10⁹ poise and less than or equal to 10¹¹ poise.

5. The method of claim 1, wherein introducing the two-dimensional glass-based preform into the preform mold comprises gravity sagging a heated two-dimensional glass-based preform into the preform mold.

6. The method of claim 1, wherein introducing the two-dimensional glass-based preform into the preform mold comprises pressing, vacuum sagging, or differential pressure sagging a heated two-dimensional glass-based preform into the preform mold.

7. The method of claim 1, wherein cooling the glass-based preform comprises active cooling.

8. The method of claim 1, wherein placing the intermediate glass-based article into the intermediate mold comprises keeping the intermediate glass-based article within the preform mold.

9. The method of claim 1, wherein heating the intermediate glass-based article to the second temperature comprises heating the intermediate glass-based article to a temperature such that the intermediate glass-based article has a viscosity that is greater than or equal to 10⁹ poise and less than or equal to 10¹¹ poise.

10. The method of claim 1, wherein heating the intermediate glass-based article to the second temperature comprises heating the intermediate glass-based article to a temperature such that the intermediate glass-based article has a viscosity that is about 10¹⁰ poise.

11. The method of claim 1, wherein the first temperature is less than the second temperature.

12. The method of claim 1, wherein forming the intermediate glass-based article in the intermediate mold comprises pressing the intermediate glass-based article into the intermediate mold.

13. The method of claim 1, wherein forming the intermediate glass-based article in the intermediate mold comprises vacuum pressing the intermediate glass-based article into the intermediate mold.

14. The method of claim 1, wherein forming the intermediate glass-based article in the intermediate mold comprises differential pressure forming the intermediate glass-based article into the intermediate mold.

15. The method of claim 1, wherein cooling the intermediate glass-based article comprises active cooling.

16. The method of claim 1, wherein placing the two-dimensional glass-based preform at the opening of the preform mold comprises holding at least a portion of a perimeter of the two-dimensional glass-based preform to the preform mold.

17. The method of claim 16, wherein the two-dimensional glass-based preform is held to the preform mold by a clamp.

18. The method of claim 16, wherein the at least a portion of the perimeter of the two-dimensional glass-based preform that is held to the preform mold is heated to a temperature that is greater than the first temperature.

19. The method of claim 1, wherein forming the intermediate glass-based article into the intermediate mold comprises holding at least a portion of a perimeter of the intermediate glass-based article to the intermediate mold.

20. The method of claim 19, wherein the intermediate glass-based article is held to the intermediate mold by a clamp.
